(19) United States
(12) Patent Application Publication
(10) Pub. No.: US 2015/0311805 A1
(43) Pub. Date: Oct. 29, 2015

(54) POWER SUPPLY DEVICE, IMAGE FORMING APPARATUS, LASER DEVICE, LASER IGNITION DEVICE, AND ELECTRONIC DEVICE

(71) Applicant: Tomofumi YAMASHITA, Saga (JP)

(72) Inventor: Tomofumi YAMASHITA, Saga (JP)

(73) Assignee: RICOH COMPANY, LTD., Tokyo (JP)

(21) Appl. No.: 14/688,047

(22) Filed: Apr. 16, 2015

(30) Foreign Application Priority Data
Apr. 24, 2014 (JP) 2014-090142
Feb. 9, 2015 (JP) 2015-022985

(51) Int. Cl. H02M 3/335; B41J 2/385; H01S 3/00

(52) U.S. Cl. CPC H02M 3/33507; H02M 3/33546; G03G 15/80

(57) ABSTRACT

A power supply device includes a power converter transformer, a coil, a first capacitor, and an energy regeneration circuit. The power converter transformer includes a primary winding and a secondary winding. The coil is provided on a primary side of the power converter transformer, and has a first end connected in series to a first end of the primary winding of the power converter transformer to store energy. The stored energy is regenerated in the first capacitor provided on the primary side of the power converter transformer by the energy regeneration circuit provided on the primary side of the power converter transformer.

### CROSS-REFERENCE TO RELATED APPLICATION

This patent application is based on and claims priority pursuant to 35 U.S.C. §119(a) to Japanese Patent Application No. 2014-090142, filed on Apr. 24, 2014, in the Japan Patent Office, and Japanese Patent Application No. 2015-022985, filed on Feb. 9, 2015, in the Japan Patent Office, the entire disclosures of which are hereby incorporated by reference herein.

### BACKGROUND

1. Technical Field

This disclosure relates to a power supply device, an image forming apparatus, a laser device, a laser ignition device, and an electronic device.

2. Related Art

Switching power supply devices used as power supplies of electronic devices are required to achieve high efficiency and low loss (heat generation). High-efficiency power supply devices are also required in image forming apparatuses, which tend to be subjected to large load fluctuations and placed in an extended standby status.

FIG. 1 illustrates an example of an insulated forward converter, which is an existing type of power supply device. The insulated forward converter is widely used as an alternating-current (AC) adapter of laptop personal computers (PCs) or a power supply of desktop PCs, for example, to convert a high input voltage into a low output voltage.

The insulated forward converter illustrated in FIG. 1, which includes a magnetic reset circuit CR, receives a direct-current (DC) voltage of 100 V input to the primary side of a transformer T and outputs a voltage Vout of 12 V. The input and output voltages of the insulated forward converter are adjustable by the ratio of transformation of the transformer T. When the insulated forward converter is used in precision instruments, for example, feedback control is performed to stabilize the voltage, reducing the fluctuation in output voltage to a substantially low level.

Since the circuit illustrated in FIG. 1 unidirectionally excites the transformer T, a coil of the transformer T starts storing energy when a transistor is turned off. Therefore, the magnetic reset circuit CR for resetting a magnetic flux is provided on the primary side of the transformer T. The magnetic reset circuit CR prevents electronic switching elements such as a transistor and a field-effect transistor (FET) from being destroyed by resetting the magnetic flux.

As another example of the power supply device, a switching power supply device may include a forward converter transformer and a flyback circuit provided on the secondary side of the forward converter transformer and including a diode and a capacitor, and the switching power supply device may shift to a flyback system when a load current falls below a predetermined value to extract energy stored in the converter transformer as a flyback output.

As still another example, a forward converter may be configured to operate differently between a rated operation mode and a light-load operation mode, and include a polarity inversion circuit having an input terminal connected to an intermediate tap located between opposed ends of a secondary winding of a transformer and an output terminal connected to a choke coil such that, in the light-load operation mode, a forward voltage generated at the opposed ends of the secondary winding in the OFF state of a switching element is partially extracted from the secondary winding, reversed in polarity by the polarity inversion circuit, and output to an output terminal on the secondary side.

### SUMMARY

In one embodiment of this disclosure, there is provided an improved power supply device that includes, in one example, a power converter transformer, a coil, a first capacitor, and an energy regeneration circuit. The power converter transformer includes a primary winding and a secondary winding. The coil is provided on a primary side of the power converter transformer, and has a first end connected in series to a first end of the primary winding of the power converter transformer to store energy. The stored energy is regenerated in the first capacitor provided on the primary side of the power converter transformer by the energy regeneration circuit provided on the primary side of the power converter transformer.

In one embodiment of this disclosure, there is provided an improved image forming apparatus that includes, for example, an image forming unit to form an image, a control unit to control the image forming unit, and the above-described power supply device.

In one embodiment of this disclosure, there is provided an improved laser device that includes, in one example, a laser to emit laser beams and the above-described power supply device to supply power to the laser to oscillate. The power supply device further includes a charging unit provided on a secondary side of the power converter transformer and including a plurality of capacitors connected in parallel and a charge current control unit to control a charge current to the charging unit.

In one embodiment of this disclosure, there is provided an improved laser ignition device that includes, for example, the above-described laser device and an optical system to collect the laser beams emitted from the laser device onto an ignition target to ignite the ignition target.

In one embodiment of this disclosure, there is provided an improved electronic device that includes, for example, the above-described power supply device.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration example of an existing insulated forward converter;

FIG. 2 is a diagram illustrating an example of calculating the typical electricity consumption (TEC) value of an image forming apparatus;

FIG. 3 is a graph illustrating TEC values in a rated operation mode and an energy-saving mode;

FIG. 4 is a diagram illustrating a configuration example of a forward power supply circuit as an example of a first embodiment of this disclosure;

FIG. 5 is a diagram illustrating a configuration example of a zeta power supply circuit as an example of the first embodiment;

FIG. 6 is a diagram illustrating a configuration example of a flyback power supply circuit as an example of the first embodiment;

FIG. 7 is a diagram illustrating a first stage of an operation of the forward power supply circuit and the zeta power supply circuit;

FIG. 8 is a diagram illustrating a second stage of the operation of the forward power supply circuit and the zeta power supply circuit;

FIG. 9 is a diagram illustrating a third stage of the operation of the forward power supply circuit and the zeta power supply circuit;

FIG. 10 is a diagram illustrating switching waveforms on a primary side at the respective stages of the operation of the forward power supply circuit and the zeta power supply circuit;

FIG. 11 is a diagram illustrating a first stage of an operation of the flyback power supply circuit;

FIG. 12 is a diagram illustrating a second stage of the operation of the flyback power supply circuit;

FIG. 13 is a diagram illustrating a third stage of the operation of the flyback power supply circuit;

FIG. 14 is a diagram illustrating switching waveforms on a primary side at the respective stages of the operation of the flyback power supply circuit;

FIG. 15 is a diagram illustrating an example of a drain-source voltage of an electronic switch in an existing power supply device;

FIG. 16 is a diagram illustrating an example of a drain-source voltage of an electronic switch in a power supply device according to the first embodiment;

FIG. 17 is a block diagram illustrating a configuration example of an image forming apparatus including the power supply device according to the first embodiment;

FIG. 18 is a diagram illustrating timing of output from a laser of a laser device including a power supply device according to a second embodiment of this disclosure;

FIG. 19 is a block diagram illustrating a configuration example of the laser device;

FIG. 20 is a block diagram illustrating a configuration example of the power supply device according to the second embodiment;

FIG. 21 is a schematic diagram illustrating a configuration example of a laser ignition device including the power supply device according to the second embodiment;

FIG. 22 is a diagram illustrating a configuration example of a single-switch flyback power supply device including a snubber circuit;

FIG. 23 is a graph illustrating an example of changes in voltage occurring in the operation of an electronic switch of a flyback power supply circuit not including a snubber circuit;

FIG. 24 is a graph illustrating an example of changes in voltage occurring in the operation of an electronic switch of a flyback power supply circuit including a snubber circuit;

FIG. 25 is a detailed graph of a drain-source voltage illustrated in FIG. 24;

FIG. 26 is a diagram illustrating a configuration example of a forward power supply circuit as an example of the second embodiment;

FIG. 27 is a diagram illustrating a configuration example of a flyback power supply circuit as an example of the second embodiment;

FIG. 28 is a diagram illustrating a configuration example of a charge current control unit in the power supply device according to the second embodiment;

FIG. 29 is a diagram illustrating another configuration example of the charge current control unit in the power supply device according to the second embodiment;

FIG. 30 is a graph illustrating unnecessary radiation noise from a single-switch flyback power supply circuit;

FIG. 31 is a graph illustrating unnecessary radiation noise from the flyback power supply circuit as an example of the second embodiment;

FIG. 32 is a graph illustrating the efficiency of the flyback power supply circuit as an example of the second embodiment under a heavy load, as compared with the efficiency of the single-switch flyback power supply circuit;

FIG. 33 is a graph illustrating the efficiency of the flyback power supply circuit as an example of the second embodiment under a light load, as compared with the efficiency of the single-switch flyback power supply circuit;

FIG. 34 is a diagram illustrating a simulation circuit of the forward power supply circuit as an example of the second embodiment;

FIG. 35 is a diagram illustrating simulation results obtained from respective units in the simulation circuit of the forward power supply circuit;

FIG. 36 is a diagram illustrating waveforms of two currents flowing through the simulation circuit of the forward power supply circuit;

FIG. 37 is a diagram illustrating a simulation circuit of the flyback power supply circuit as an example of the second embodiment;

FIG. 38 is a diagram illustrating simulation results obtained from respective units in the simulation circuit of the flyback power supply circuit under a heavy load; and

FIG. 39 is a diagram illustrating simulation results obtained from the respective units in the simulation circuit of the flyback power supply circuit under a light load.

The accompanying drawings are intended to depict example embodiments of this disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same function, operate in a similar manner, and achieve a similar result.

Referring now to the drawings, wherein like reference numerals designate identical or corresponding parts throughout the several views, configurations according to embodiments of this disclosure will be described in detail.

To visualize the power consumption of electronic devices, the typical electricity consumption (TEC) value is used. The TEC value is indicative of the weekly power consumption (kWh) in a model case, and serves as a reference value to meet the International Energy Star Program operated by The Energy Conservation Center, Japan.

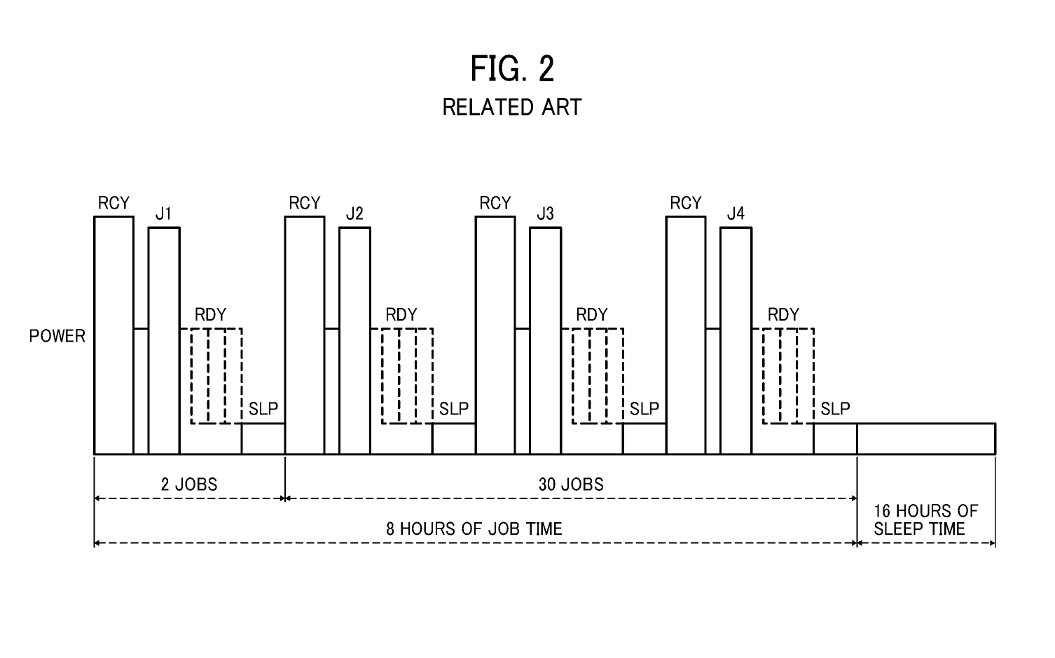

An example of calculation of the TEC value will now be described with reference to FIG. 2.

FIG. 2 is a diagram illustrating an example of calculating the TEC value of an image forming apparatus. For example, an image forming apparatus, such as a printer or a multifunction peripheral, used in an average office environment is expected to have 8 hours of running time (i.e., job time) and 16 hours of sleep time on a weekday.

For instance, the image forming apparatus performs a 15-minute job twice during the job time; first in the morning and after a lunch break (i.e., job J1 in FIG. 2). In each of the jobs, the image forming apparatus performs a recovery operation RCY and a job Jm (m represents an integer ranging from 1 to 4) by consuming a relatively large amount of power, and shifts to a ready state RDY indicated by broken lines and then to a sleep state SLP, with the power consumption reduced from rated power in the job Jm to standby power in the ready state RDY and then to energy-saving power in the sleep state SLP.

After the two jobs, the image forming apparatus repeats ten cycles of performing jobs J2, J3, and J4 at intervals of 15 minutes to perform 30 jobs in total. In each of the cycles, the power consumption is measured for each of the three jobs, and the mean thereof is calculated. In a print operation, the power consumption is determined by a function of a specified number of prints based on pages per minute (ppm) (e.g., 12 prints for 25 ppm, 19 prints for 35 ppm, 31 prints for 45 ppm, . . . , 51 prints for 60 ppm, and 87 prints for 75 ppm). The TEC value (kWh) is then calculated by adding the power consumption during five weekdays to the power consumption in the sleep state during the weekend (i.e., 24 hours×2 days).

As described above, the power consumption of the image forming apparatus varies substantially depending on a wide range of load from a light load to a heavy load. Further, the image forming apparatus has an the extended sleep period, in which the image forming apparatus is subjected to a light load of approximately 50 mA to approximately 200 mA. To improve the TEC value, therefore, the image forming apparatus needs to maintain high efficiency in a wide range of load from a load in the sleep state (approximately 50 mA to approximately 200 mA) to a load in the job (approximately 12 A to approximately 20 A), which is 100 times greater than the load in the sleep state.

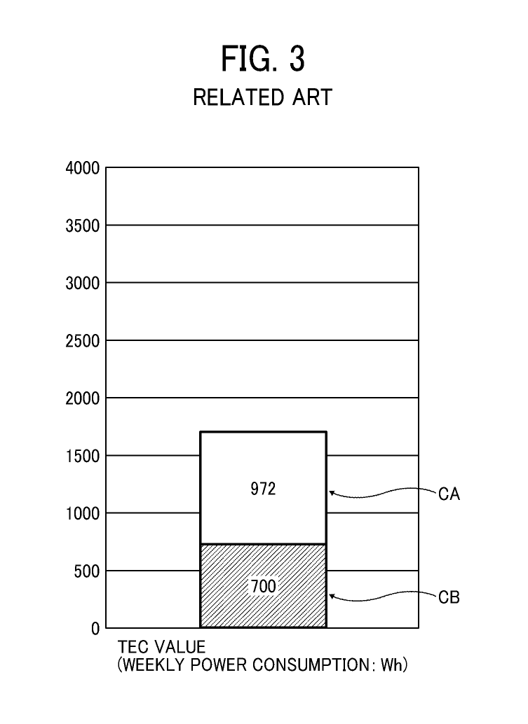

FIG. 3 is a graph illustrating the TEC value in a rated operation mode and the TEC value in an energy-saving mode. As illustrated in FIG. 3, a weekly power consumption CA in the energy-saving mode exceeds a weekly power consumption CB in the rated operation mode. To reduce the TEC value, it is particularly preferable to achieve high efficiency in the extended sleep time. Further, the TEC value is convertible to the standard CO₂ emission based on the original unit “0.555 kg-CO₂/1 kWh” specified by the Ministry of the Environment in Japan. That is, the TEC value is directly related to the environment.

To increase the efficiency over a wide range of loads from a light load to a heavy load, a switching power supply device may be configured to drive a secondary circuit as a forward converter under the heavy load and as a flyback converter under the light load. In particular, the efficiency under the light load depends on the power consumed by circuits such as a snubber circuit for preventing a surge voltage due to the self-inductance of a primary circuit and a circuit for resetting magnetic saturation, since such circuits including capacitors, resistors, and diodes consume a large amount of power.

A first embodiment of this disclosure will now be described.

A power supply device 1 according to the present embodiment includes a power converter transformer, and a coil, a capacitor, and an energy regeneration circuit provided on a primary side of the power converter transformer. The coil is connected in series to a primary winding of the power converter transformer to store energy, and the energy stored in the coil is regenerated in the capacitor by the energy regeneration circuit.

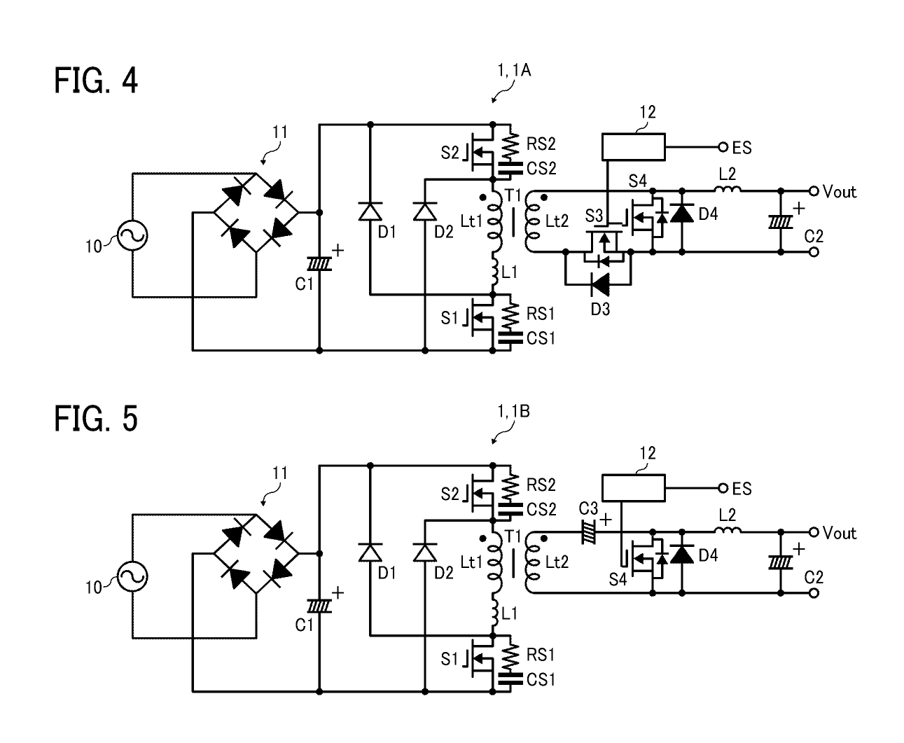

For example, as illustrated in FIG. 4, the power supply device 1 according to the present embodiment may be implemented as a forward power supply device 1A including a transformer T1, a coil L1, an input capacitor C1, a first electronic switch S1, a second electronic switch S2, a first diode D1, and a second diode D2, in which the first electronic switch S1, the second electronic switch S2, the first diode D1, and the second diode D2 cooperate as an energy regeneration circuit.

Specifically, the power supply device 1 according to the present embodiment corresponds to a regular power supply circuit additionally provided with a coil for generating regenerative energy (i.e., the coil L1) not magnetically coupled to the power converter transformer (i.e., the transformer T1), and electronic switches (i.e., the first electronic switch S1 and the second electronic switch S2) and diodes (i.e., the first diode D1 and the second diode D2) for collecting the surge energy in the capacitor (i.e., the input capacitor C1). With this configuration, the power supply device 1 according to the present embodiment maintains high efficiency unaffected by leakage inductance of the power converter transformer.

Depending on the configuration of the secondary circuit, the power supply device 1 according to the present embodiment functions as the forward power supply circuit 1A (i.e., a dual-switch forward converter), a zeta power supply circuit 1B (i.e., a dual-switch zeta converter), or a flyback power supply circuit 1C (i.e., a dual-switch flyback converter).

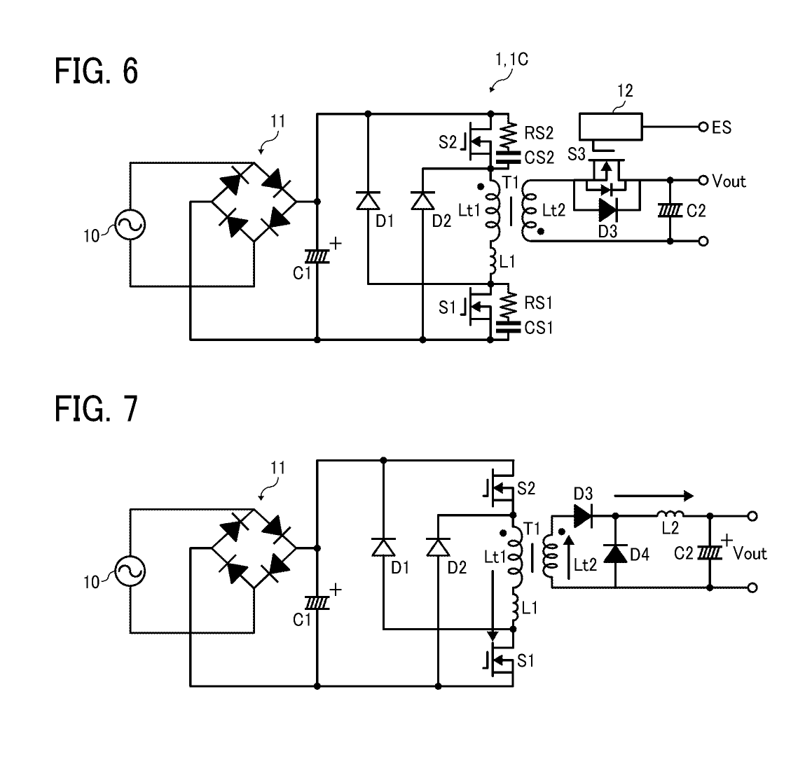

FIG. 4 is a diagram illustrating a configuration example of the forward power supply circuit 1A as an example of the power supply device 1. FIG. 5 is a diagram illustrating a configuration example of the zeta power supply circuit 1B as an example of the power supply device 1. FIG. 6 is a diagram illustrating a configuration example of the flyback power supply circuit 1C as an example of the power supply device 1.

The forward power supply circuit 1A, the zeta power supply circuit 1B, and the flyback power supply circuit 1C are the same in the configuration of the primary circuit located on the primary (input) side of the power converter transformer. The primary circuit is a dual-switch surge regeneration circuit. However, the forward power supply circuit 1A, the zeta power supply circuit 1B, and the flyback power supply circuit 1C are different in the configuration of the secondary circuit located on the secondary (output) side of the power converter transformer. The secondary circuit and the power converter transformer determine the suitable output power level and the circuit configuration, for example.

The forward power supply circuit 1A illustrated in FIG. 4 will now be described.

The forward power supply circuit 1A includes a rectifier bridge 11 formed of diodes and a power converter transformer T1. The rectifier bridge 11 is connected to an AC power supply 10 to which a voltage of 100 V is input. The power converter transformer (also simply referred to as the transformer) T1 includes a coil Lt1 and a coil Lt2, i.e., a primary winding and a secondary winding.

The primary circuit of the forward power supply circuit 1A includes an input capacitor C1, a first diode D1, a second diode D2, a first electronic switch S1, a second electronic switch S2, a capacitor CS1, a resistor RS1, a capacitor CS2, a resistor RS2, and a coil L1 to form the dual-switch surge regeneration circuit.

The anode of the first diode D1 is connected to the drain of the first electronic switch S1, and the cathode of the first diode D1 is connected to the drain of the second electronic switch S2. The coil L1 is not magnetically coupled to the transformer T1, and stores regenerative energy. The regenerative energy stored in the coil L1 is regenerated in the input capacitor C1 via the first diode D1. With the inductance value of the coil L1, an output current is controlled to achieve the highest efficiency. The inductance of the coil L1 is set to a value unaffected by leakage inductance of the transformer T1.

The first electronic switch S1 is provided to one end of the coil L1, and the second electronic switch S2 is provided to one end of the coil Lt1 of the transformer T1. A damper formed of the capacitor CS1 and the resistor RS1 is connected between the drain and the source of the first electronic switch S1, and a damper formed of the capacitor CS2 and the resistor RS2 is connected between the drain and the source of the second electronic switch S2. The anode of the second diode D2 is connected to the source of the first electronic switch S1 to serve as a clamper for clamping a surge voltage between the drain and the source of the first electronic switch S1, and the cathode of the second diode D2 is connected to the source of the second electronic switch S2 to serve as a clamper for clamping a surge voltage between the drain and the source of the second electronic switch S2.

For example, it is preferable to connect a capacitor of approximately 1000 pF and a resistor of approximately 10Ω between the drain and the source of each of the first electronic switch S1 and the second electronic switch S2. This configuration substantially reduces unnecessary radiation noise.

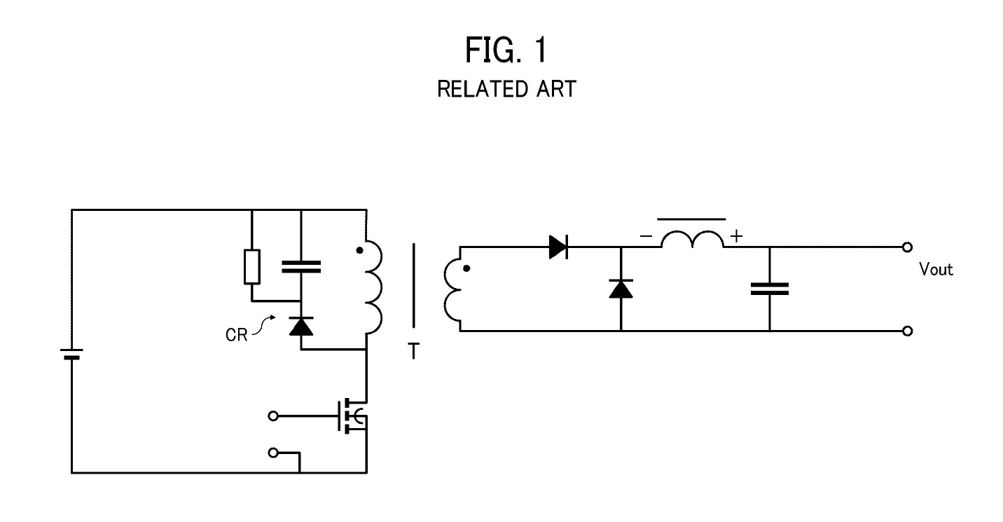

With the above-configured clampers and dampers, the primary circuit suppresses noise from the first electronic switch S1, the second electronic switch S2, and the transformer T1, reducing unnecessary radiation noise (i.e., electromagnetic interference: EMI) with a simple configuration. The primary circuit according to the present embodiment does not include a magnetic reset circuit such as the magnetic reset circuit CR illustrated in FIG. 1. Further, in the present embodiment, the transformer T1 outputs a voltage when the first electronic switch S1 and the second electronic switch S2 are ON.

The secondary circuit of the forward power supply circuit 1A includes a coil (choke coil) L2, an output capacitor C2, a third diode D3, and a fourth diode D4.

Preferably, the secondary circuit further includes a synchronous rectifier circuit including a synchronous rectifier controller 12, to which an energy-saving mode signal ES is input. In this case, for example, the synchronous rectifier controller 12, the transformer T1, a third electronic switch S3, a fourth electronic switch S4, the third diode D3, the fourth diode D4, and the coil L2 cooperate as the synchronous rectifier circuit. With the synchronous rectifier circuit provided in the secondary circuit, there is no diode forward voltage drop, thereby increasing the efficiency under a heavy load.

However, under a light load in the energy-saving mode, such as when a load current of tens of milliamperes flows, for example, even slight power consumption by the synchronous rectifier circuit affects the efficiency. The secondary circuit therefore includes the third electronic switch S3 and the fourth electronic switch S4, which form a switch circuit serving as an energy-saving mode switch that cuts off the synchronous rectifier circuit under a light load.

The third diode D3 and the fourth diode D4 serving as Schottky barrier diodes are connected in parallel to parasitic diodes (i.e., body diodes) of the third electronic switch S3 and the fourth electronic switch S4, which are field-effect transistors (FETs) for operating the synchronous rectifier circuit. Under a light load, therefore, a current flows through the third diode D3 and the fourth diode D4 serving as rectifier diodes.

Under a heavy load in the rated operation mode, a current flows through the internal diodes of the third electronic switch S3 and the fourth electronic switch S4. In the present configuration, the third diode D3 and the fourth diode D4 are connected in parallel to the third electronic switch S3 and the fourth electronic switch S4. Therefore, the current flows to the third diode D3 and the fourth diode D4 having a low impedance, thereby improving the efficiency.

The third diode D3 and the fourth diode D4 effectively reduce the forward voltage drop in the internal diodes of the third electronic switch S3 and the fourth electronic switch S4, thereby substantially increasing the efficiency under both the heavy load and the light load. The third diode D3 and the fourth diode D4 preferably reduce the forward voltage drop to 0.6 V or less, for example.

If the secondary circuit does not include the synchronous rectifier circuit, the third electronic switch S3 and the fourth electronic switch S4 serving as the energy-saving mode switch are unnecessary. In such a case, therefore, the secondary circuit may include the third diode D3 and the fourth diode D4 without the third electronic switch S3 and the fourth electronic switch S4, as illustrated in FIG. 7, for example.

The zeta power supply circuit 1B illustrated in FIG. 5 will now be described.

The primary circuit of the zeta power supply circuit 1B is similar in configuration to that of the forward power supply circuit 1A illustrated in FIG. 4.

The secondary circuit of the zeta power supply circuit 1B serves as a zeta converter circuit. The zeta power supply circuit 1B is different from the forward power supply circuit 1A illustrated in FIG. 4 in that an output coupling capacitor C3 is connected in place of the third electronic switch S3 and the third diode D3.

The operation of the forward power supply circuit 1A illustrated in FIG. 4 and the zeta power supply circuit 1B illustrated in FIG. 5 will now be described with reference to FIGS. 7 to 10, in which elements of the primary circuit unrelated to the description are omitted. The following description will be given of an example in which the secondary circuit includes the coil L2, the output capacitor C2, the third diode D3, and the fourth diode D4 but no synchronous rectifier circuit.

As illustrated in FIG. 7, at a first stage at which the first electronic switch S1 and the second electronic switch S2 are ON and the first diode D1 and the second diode D2 are OFF, a current flows through the coil Lt1 of the transformer T1 (i.e., a primary inductor of the transformer T1) and the coil L1. The current also flows to the secondary circuit. Thereby, the secondary circuit stores energy in the coil L2, charges the output capacitor C2, and outputs a DC voltage Vout.

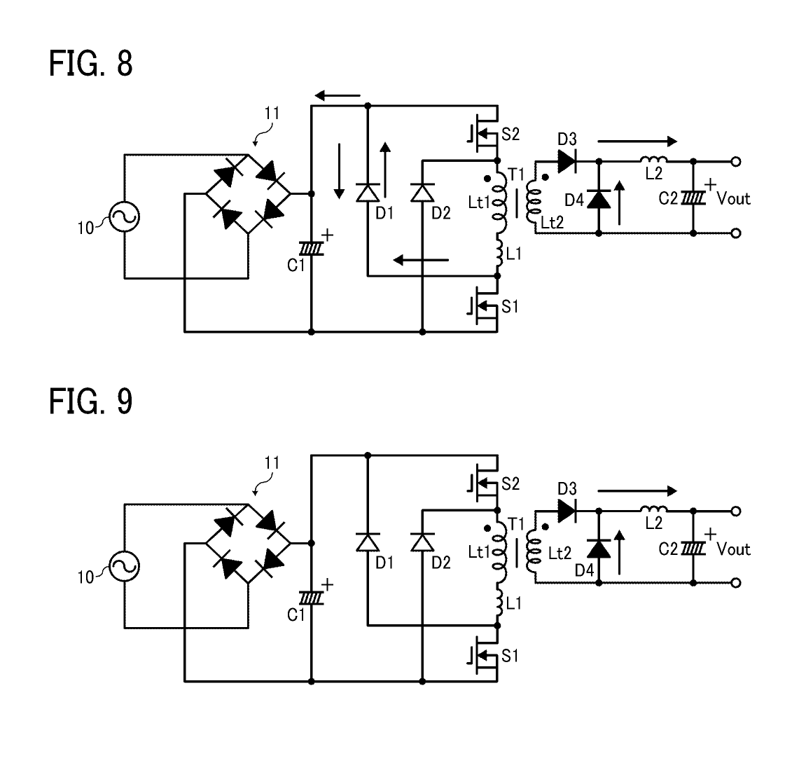

Further, as illustrated in FIG. 8, at a second stage at which the first electronic switch S1 and the second electronic switch S2 are OFF and the first diode D1 and the second diode D2 are ON, the secondary circuit charges the output capacitor C2 with the energy stored in the coil L2 via the fourth diode D4 serving as a communication diode, and outputs the DC voltage Vout.

Further, as illustrated in FIG. 9, at a third stage at which the first electronic switch S1 and the second electronic switch S2 are OFF and the first diode D1 and the second diode D2 are OFF, the secondary circuit charges the output capacitor C2 with the energy stored in the coil L2 via the fourth diode D4 serving as a communication diode, and outputs the DC voltage Vout.

In the forward power supply circuit 1A and the zeta power supply circuit 1B, the current thus flows to the secondary circuit whether the first electronic switch S1 and the second electronic switch S2 are ON or OFF.

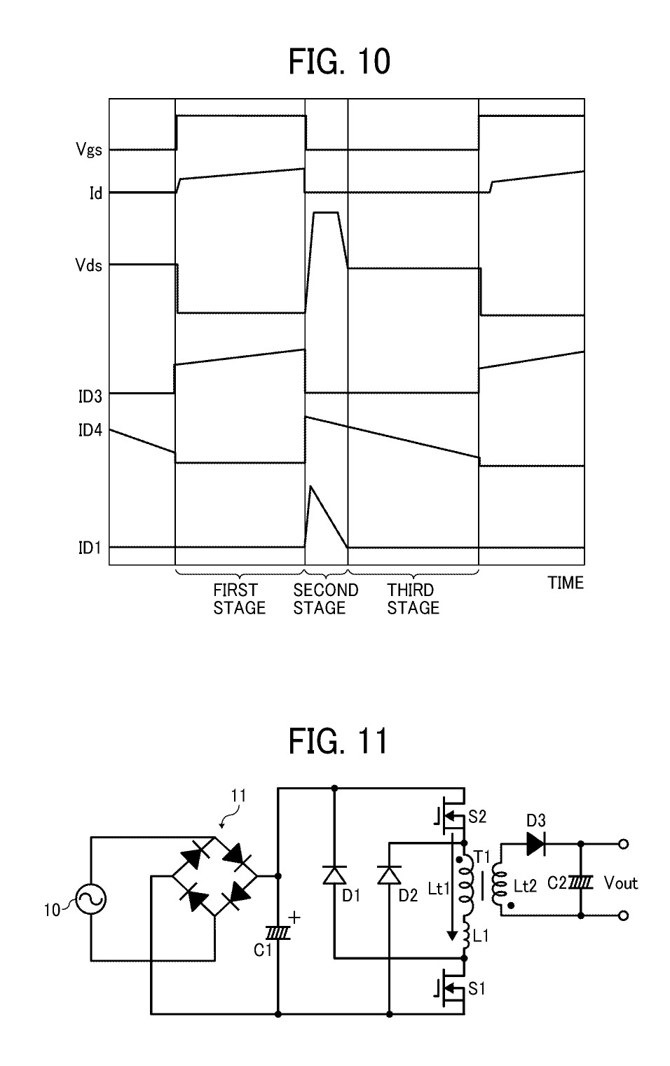

FIG. 10 is a diagram illustrating switching waveforms on the primary side of the transformer T1 at the first to third stages of the operation described above; respective switching waveforms of a gate-source voltage Vgs of each of the first electronic switch S1 and the second electronic switch S2, a drain current Id in each of the first electronic switch S1 and the second electronic switch S2, a drain-source voltage Vds of each of the first electronic switch S1 and the second electronic switch S2, a current ID3 flowing through the third diode D3 (i.e., output current), a current ID4 flowing through the fourth diode D4 (i.e., output current), and a current ID1 flowing through the first diode D1 (i.e., regenerative current).

The flyback power supply circuit 1C illustrated in FIG. 6 will now be described.

The primary circuit of the flyback power supply circuit 1C is similar in configuration to that of the forward power supply circuit 1A illustrated in FIG. 4.

The secondary circuit of the flyback power supply circuit 1C serves as a flyback circuit. The flyback power supply circuit 1C is different from the forward power supply circuit 1A illustrated in FIG. 4 and the zeta power supply circuit 1B illustrated in FIG. 5 in that the transformer T1 outputs a voltage when the first electronic switch S1 and the second electronic switch S2 are OFF, and that the fourth electronic switch S4 and the fourth diode D4 illustrated in FIG. 4 serving as a communication diode are not connected. Herein, the DC voltage Vout output from the secondary circuit is 5 V.

The operation of the flyback power supply circuit 1C illustrated in FIG. 6 will now be described with reference to FIGS. 11 to 14, in which elements of the primary circuit unrelated to the description are omitted. The following description will be given of an example in which the secondary circuit includes the output capacitor C2 and the third diode D3 but no synchronous rectifier circuit.

As illustrated in FIG. 11, at the first stage at which the first electronic switch S1 and the second electronic switch S2 are ON and the first diode D1 and the second diode D2 are OFF, a current flows through the coil Lt1 of the transformer T1 (i.e., the primary inductor of the transformer T1) and the coil L1, but no current flows to the secondary circuit.

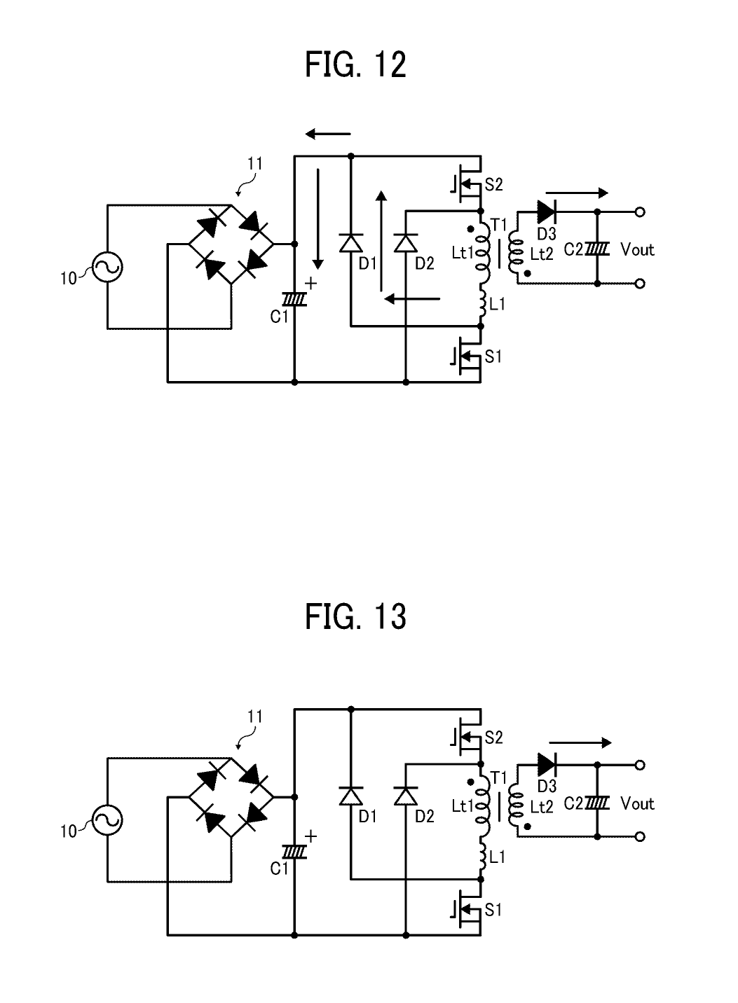

Further, as illustrated in FIG. 12, at the second stage at which the first electronic switch S1 and the second electronic switch S2 are OFF and the first diode D1 and the second diode D2 are ON, the energy stored in the coil Lt1 of the transformer T1 is flown back to the secondary circuit to charge the output capacitor C2, and the secondary circuit outputs the DC voltage Vout. Further, the energy stored in the coil L1 is regenerated in the input capacitor C1.

Further, as illustrated in FIG. 13, at the third stage at which the first electronic switch S1 and the second electronic switch S2 are OFF and the first diode D1 and the second diode D2 are OFF, the energy stored in the coil Lt1 of the transformer T1 is flown back to the secondary circuit to charge the output capacitor C2, and the secondary circuit outputs the DC voltage Vout.

In the flyback power supply circuit 1C, the current thus flows to the secondary circuit at the second and third stages at which the first electronic switch S1 and the second electronic switch S2 are OFF.

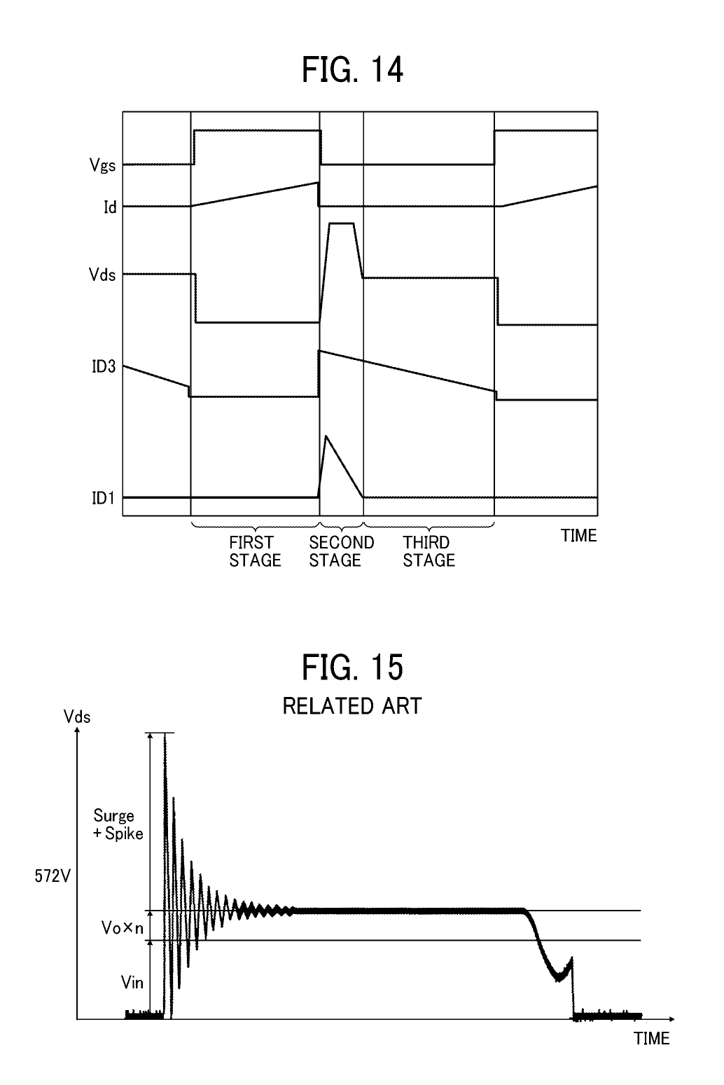

FIG. 14 is a diagram illustrating switching waveforms on the primary side of the transformer T1 at the first to third stages of the operation described above; the respective switching waveforms of the gate-source voltage Vgs of each of the first electronic switch S1 and the second electronic switch S2, the drain current Id in each of the first electronic switch S1 and the second electronic switch S2, the drain-source voltage Vds of each of the first electronic switch S1 and the second electronic switch S2, the current ID3 flowing through the third diode D3 (i.e., output current), and the current ID1 flowing through the first diode D1 (i.e., regenerative current).

The above-described power supply device 1 achieves high efficiency in a wide output power range from approximately 1 W to approximately 1 KW, for example, both under a light load mode and a heavy load mode (i.e., the energy-saving mode and the rated operation mode). Further, the power supply device 1 employing a single-converter system contributes to a reduction in device size. The power supply device 1 also reduces unnecessary radiation noise (i.e., EMI) with a simple configuration, facilitating the prevention of radio interference.

For instance, FIG. 15 illustrates an example of the drain-source voltage Vds of an electronic switch, such as a FET or a transistor, in an existing power supply device. When the electronic switch is turned on and off at high speed, a high surge voltage is generated by self-inductance, which may destroy the electronic switch and other elements or cause unnecessary radiation noise. In this example, a high voltage of 572 V is generated as the drain-source voltage Vds of the electronic switch. Herein, the drain-source voltage Vds is expressed as Vds=Vin+Voxn+Surge+Spike, wherein Vin, Vo, n, Surge, and Spike represent the input voltage, the output voltage, the turn ratio of the transformer, a surge voltage, and a spike voltage, respectively.

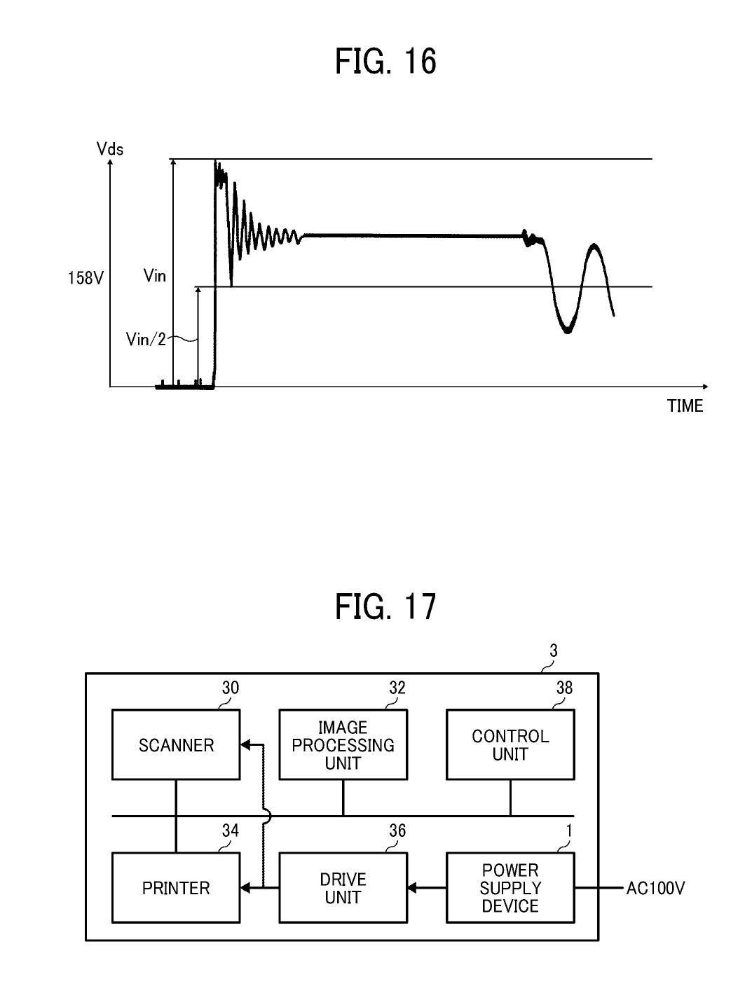

By contrast, FIG. 16 illustrates an example of the drain-source voltage Vds of each of the first electronic switch S1 and the second electronic switch S2 in the power supply device 1 according to the present embodiment. In the present embodiment, the surge voltage is clamped by the two electronic switches S1 and S2 and the two diodes D1 and D2. Further, the damper formed of the capacitor CS1 and the resistor RS1 is connected between the drain and the source of the first electronic switch S1 and the damper formed of the capacitor CS2 and the resistor RS2 is connected between the drain and the source of the second electronic switch S2. Consequently, the drain-source voltage Vds is almost equal to the input voltage Vin with no surge voltage (i.e., Vds≈Vin), as illustrated in FIG. 16. In the present embodiment, the drain-source voltage Vds is 158 V.

An image forming apparatus including the power supply device 1 according to the present embodiment will now be described.

FIG. 17 is a block diagram illustrating a configuration example of an image forming apparatus 3 including the power supply device 1 according to the present embodiment. The image forming apparatus 3 is a multifunction peripheral, for example, including a scanner 30, an image processing unit 32, a printer (i.e., an image forming unit) 34, a drive unit 36, a control unit 38, and the power supply device 1.

The scanner 30 reads the image of a document. The image processing unit 32 performs a predetermined process on the image read by the scanner 30, for example, and outputs the processed image to the printer 34. The printer 34 prints the image received from the image processing unit 32. The drive unit 36 operates at a voltage of 24 V, for example, to drive movable units such as the scanner 30 and the printer 34, based on electric power supplied from the power supply device 1. The control unit 38 controls the respective units of the image forming apparatus 3, and may be implemented by a central processing unit (CPU) and a memory such as a read only memory and a random access memory.

The application of the power supply device 1 is not limited to the image forming apparatus 3, and is also applicable to other electronic devices requiring a power supply in a wide output range from the heavy load (e.g., rated driving) to the light load (e.g., standby driving and sleep driving).

Further, the flyback power supply circuit 1C is suitable for outputting low power, and may be used for a logic circuit that outputs power of approximately 100 W or lower, for example. The forward power supply circuit 1A is suitable for outputting intermediate power. The zeta power supply circuit 1B is suitable for outputting high power, e.g., high power of approximately 500 W to drive a motor of an image forming apparatus. The above-described power supply circuits are also applicable to power supply devices that are capable of outputting further higher power to output power of a few hundred watts to a few kilowatts with high efficiency. For example, the above-described power supply circuits are applicable to power supply devices of laser devices and other electronic devices.

A power supply device according to a second embodiment of this disclosure will now be described. Description of elements of the present embodiment similar to those of the first embodiment will be omitted.

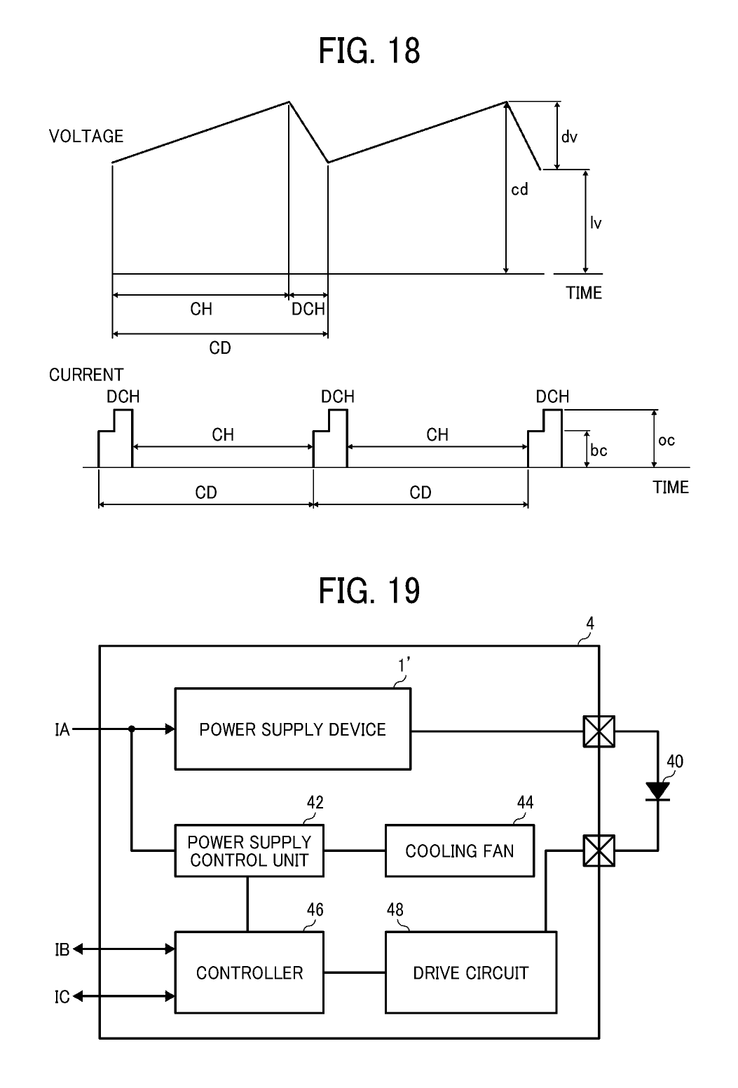

As described above, a power supply device according to an embodiment of this disclosure is applicable to the power supply of a laser device, for example. To output a current in pulses to make laser beams oscillate in pulses, for example, a power supply device 1′ according to the second embodiment includes an output capacitor as a charging unit. Thereby, a cycle of charge and discharge is repeated with a charge period CH and a discharge period DCH repeated as illustrated in FIG. 18, for example. FIG. 18 illustrates a charge-discharge period CD, a charge voltage cd, a discharge drop voltage dv, a laser oscillation threshold voltage lv, a bias current bc, and an output current oc. With this configuration, a high-current pulse output is obtained even if a small amount of current flows through an AC-DC power converter of the power supply device 1′. That is, a small, high-efficiency power supply device is realized. The power supply device 1′ according to the second embodiment is also capable of outputting a constant current as described later, which is a required feature of the power supply for causing laser oscillation.

FIG. 19 is a block diagram illustrating a configuration example of a laser device 4 including the power supply device 1′ according to the second embodiment. The laser device 4 includes the power supply device 1′, a semiconductor laser 40, a power supply control unit 42, a cooling fan 44, a controller 46, and a drive circuit 48. FIG. 19 also illustrates an AC input IA, a PC input/output IB, and an analog input/output IC.

The power supply device 1′ serves as a power supply for the semiconductor laser 40. The power supply control unit 42 controls power supply to the cooling fan 44 and the controller 46. The cooling fan 44 serves as a cooler for cooling the laser device 4. The controller 46 serves as a control unit that controls the respective units of the laser device 4, and may be implemented by a processor and a memory. The drive circuit 48 serves as a drive unit for controlling the driving of the semiconductor laser 40.

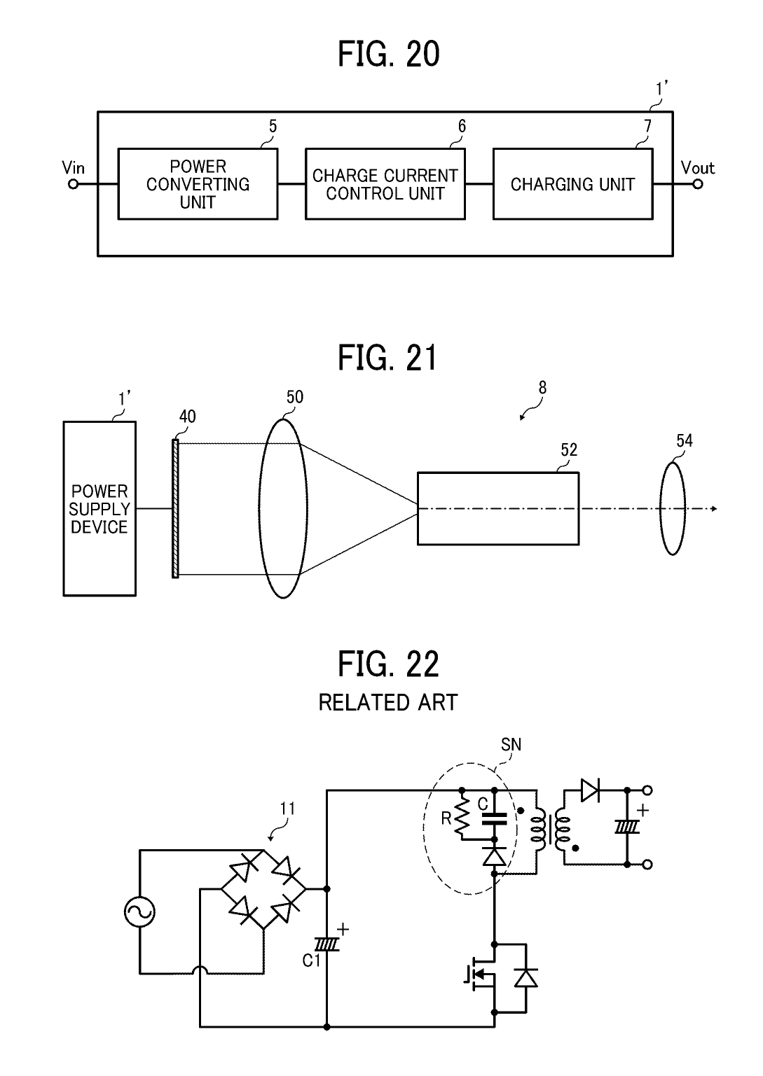

FIG. 20 is a block diagram illustrating a configuration example of the power supply device 1′ according to the present embodiment. The power supply device 1′ includes a power converting unit (AC-DC power converter) 5, a charge current control unit 6, and a charging unit 7.

The power converting unit 5 corresponds to the forward power supply circuit 1A, the zeta power supply circuit 1B, or the flyback power supply circuit 1C as an example of the power supply circuit 1 according to the first embodiment. The charge current control unit 6 includes a current sensor or a resistor, for example. The charging unit 7 includes a plurality of capacitors connected in parallel, for example, thereby having a large capacitance of several F.

A typical example of the laser device is a laser processing apparatus that performs a variety of mechanical processings difficult to perform with a cutter, such as marking (e.g., printing or engraving) for writing letters or drawing figures, peeling, deburring, cutting, and trimming, by using a laser beam in a cutting process. For example, the laser processing apparatus irradiates a target object placed on a table with a laser beam emitted from a laser via an optical system while moving the table with a driving mechanism.

Further, studies have been made on the application of the laser device to a spark plug, i.e., a laser spark plug (i.e., laser ignition device) that excites a laser medium with a semiconductor laser and concentrates resultant laser beams onto fuel to ignite the fuel. The laser ignition device is expected to be applied to cogeneration systems using fuels such as natural gas and petroleum and spark plugs for use in gas vehicles to realize higher energy efficiency than that of an electrical spark ignition system.

FIG. 21 illustrates a configuration example of a laser ignition device 8 including the power supply device 1′ according to the second embodiment. The laser ignition device 8 includes the power supply device 1′, the semiconductor laser 40 connected to the power supply device 1′, a first optical system 50 that collects laser beams emitted from the semiconductor laser 40, a laser resonator 52 that receives the collected laser beams and oscillates under photoexcitation, and a second optical system 54 that collects laser beams emitted from the laser resonator 52.

In the laser ignition device 8, the semiconductor laser 40 generates laser beams for excitation, and the first optical system 50 collects the laser beams for excitation to be incident on the laser resonator 52. Then, the laser beams oscillate in the laser resonator 52 and emitted from the laser resonator 52. The second optical system 54 then collects the emitted laser beams in a combustion chamber by to ignite fuel as an ignition target.

In such a laser device, a power supply device for performing AC-DC conversion is required to be small in size and provide high power, high efficiency, and low noise. As the power supply device for such a laser device, a single-switch forward power supply circuit (e.g., the circuit illustrated in FIG. 1) or a single-switch flyback power supply circuit is typically used. FIG. 22 illustrates an example of a single-switch flyback power supply circuit including a snubber circuit SN.

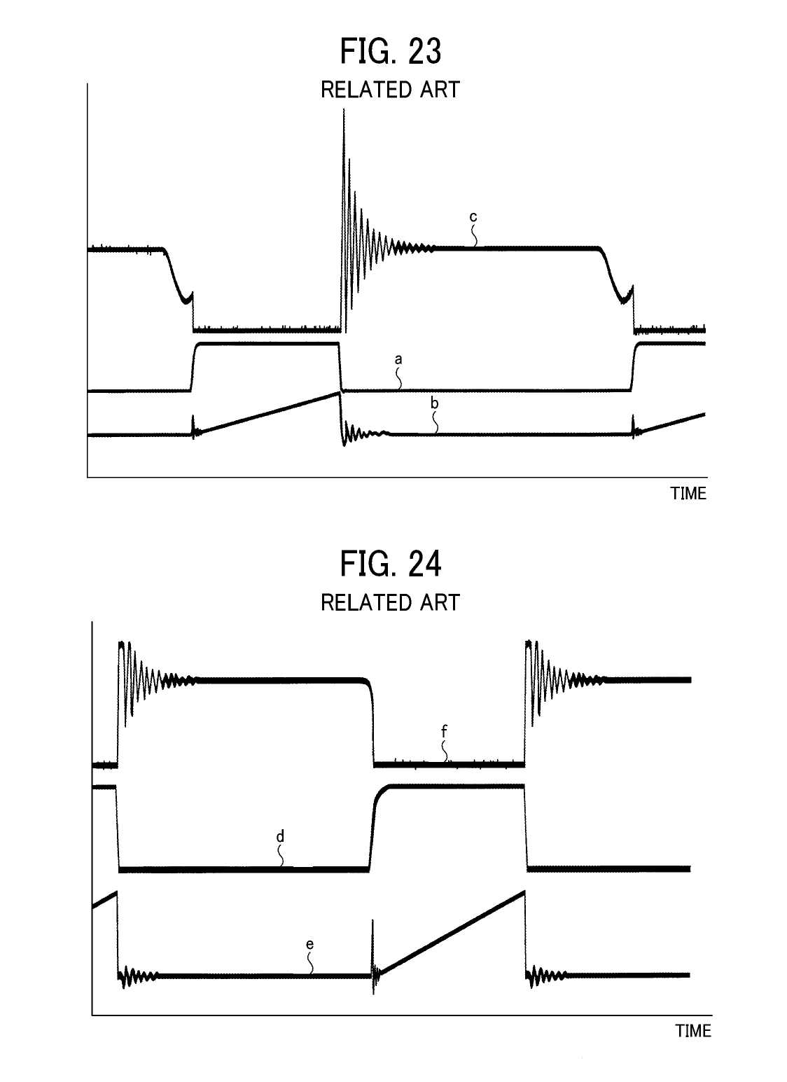

The flyback power supply circuit is advantageous in not requiring many components, having a simple configuration, and allowing a wide input voltage range. As a reference, FIG. 23 presents a graph illustrating an example of changes in voltage occurring in the operation of an electronic switch (i.e., a FET) of a flyback power supply circuit not including a snubber circuit. Specifically, FIG. 23 illustrates a gate voltage a, a drain current b, and a drain-source voltage c. As illustrated in FIG. 23, when the electronic switch is turned off, i.e., when the gate voltage a shifts from a high level to a low level, a high voltage is generated as the drain-source voltage c. The drain-source voltage c illustrated in FIG. 23 corresponds to the drain-source voltage Vds including a large surge and a large spike illustrated in FIG. 15 described above. As illustrated in FIG. 15, the drain-source voltage Vds (i.e., the drain-source voltage c in FIG. 23) is 572 V.

FIG. 24 is a graph illustrating an example of changes in voltage occurring in the operation of an electronic switch (i.e., a FET) of the single-switch flyback power supply circuit including the snubber circuit SN illustrated in FIG. 22. Specifically, FIG. 24 illustrates a gate voltage d, a drain current e, and a drain-source voltage f. As illustrated in FIG. 24, the snubber circuit SN suppresses the surge, reducing the drain-source voltage f. That is, the electronic switch and surrounding electronic components are prevented from being damaged, and the EMI is minimized. In this case, however, the surge energy is simply discharged as heat, and thus there is no improvement in efficiency.

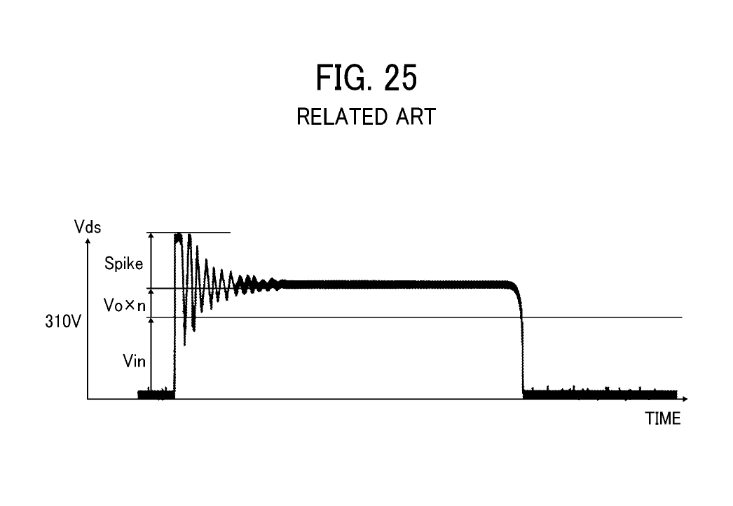

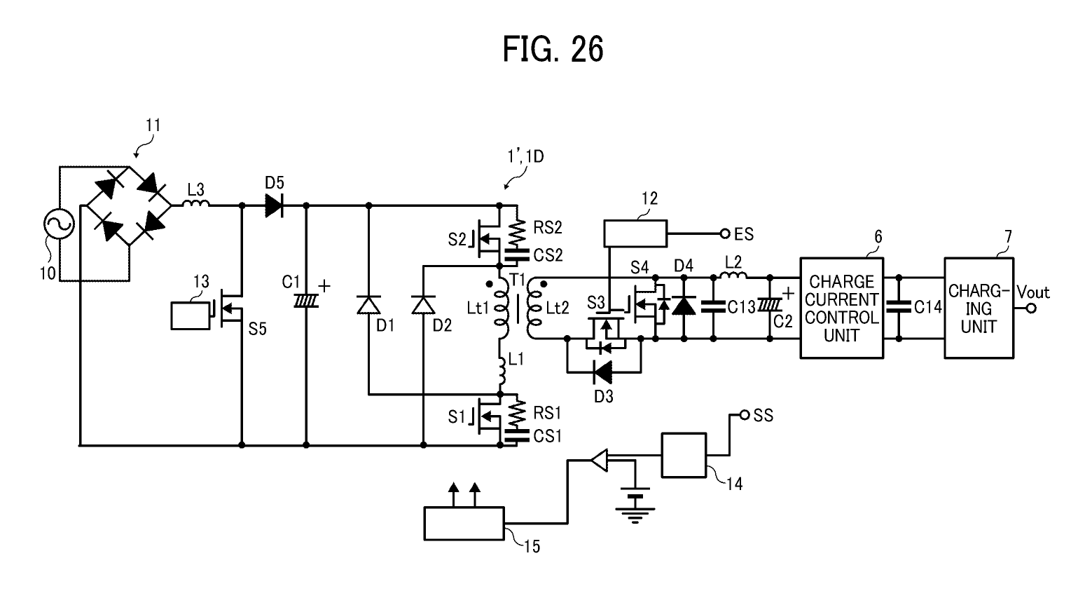

The drain-source voltage f illustrated in FIG. 24 corresponds to the drain-source voltage Vds illustrated in more detail in FIG. 25. As illustrated in FIG. 25, the drain-source voltage Vds (i.e., the drain-source voltage f in FIG. 24) is reduced to 310 V. Herein, the surge voltage is clamped and removed, but the spike voltage remains (i.e., Vds=Vin+Voxn+Spike). Further, the surge energy is discharged as heat, but there is no improvement in efficiency, as described above. Moreover, the sharp rise in the drain-source voltage f of the electronic switch increases noise.

Therefore, the power supply device 1′ according to the second embodiment is configured as follows. That is, as illustrated in FIG. 20, the charging unit 7 including a plurality of capacitors connected in parallel is connected to the power converting unit 5 (i.e., the dual-switch forward power supply circuit 1A or the dual-switch flyback power supply circuit 1C as an example of the power supply device 1 according to the first embodiment). Specifically, the charging unit 7 is connected to the secondary side of the transformer T1 of the forward power supply circuit 1A or the flyback power supply circuit 1C, and the charge current control unit 6 is interposed therebetween to control the charge current supplied from the power converting unit 5 to the charging unit 7, thereby controlling the power converting unit 5 to output a constant current.

The power converting unit 5 is not limited to the dual-switch forward power supply circuit 1A and the dual-switch flyback power supply circuit 1C as examples of the power supply device 1 according to the first embodiment, and may be the dual-switch zeta power supply circuit 1B as an example of the power supply device 1 according to the first embodiment, or may be a different type of dual-switch forward power supply circuit, zeta power supply circuit, or flyback power supply circuit as described below.

FIG. 26 is a diagram illustrating a configuration example of a forward power supply circuit 1D as an example of the power supply device 1′ according to the second embodiment suitable for the laser device 4 illustrated in FIG. 19.

The primary circuit of the forward power supply circuit 1D illustrated in FIG. 26 is a combination of the forward power supply circuit 1A as an example of the power supply device 1 according to the first embodiment illustrated in FIG. 4 and a power factor correction (PFC) circuit including a PFC controller 13, a fifth electronic switch S5, a coil L3, and a fifth diode D5 to improve the power factor. The primary circuit of the forward power supply circuit 1D, however, is not limited to this configuration, and may be similar to that of the forward power supply circuit 1A illustrated in FIG. 4.

The secondary circuit of the forward power supply circuit 1D illustrated in FIG. 26 includes the charging unit 7 having a plurality of capacitors connected in parallel and the charge current control unit 6 that controls the charge current to the charging unit 7. Further, the secondary circuit of the forward power supply circuit 1D preferably includes film capacitors C13 and C14.

The secondary circuit of the forward power supply circuit 1D further includes an output voltage switching unit 14 to which an output voltage switching signal SS is input and a switch controller 15 that controls ON and OFF of the first electronic switch S1 and the second electronic switch S2. In the output of a bias current, therefore, the output voltage is reduced based on the output voltage switching signal SS, improving the energy efficiency.

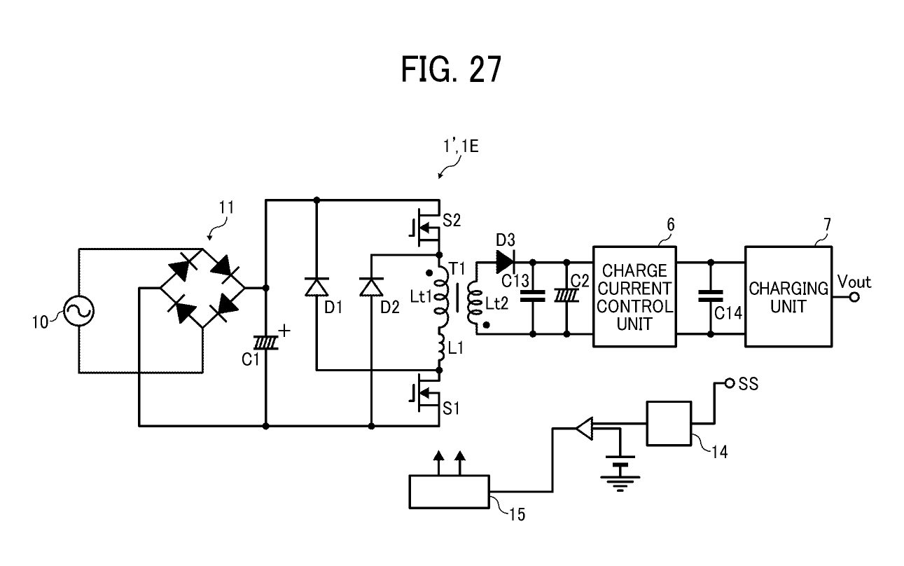

FIG. 27 is a diagram illustrating a configuration example of a flyback power supply circuit 1E as an example of the power supply device 1′ according to the second embodiment. The primary circuit of the flyback power supply circuit 1E illustrated in FIG. 27 is similar to that of the flyback power supply circuit 1C illustrated in FIG. 11 as an example of the power supply device 1 according to the first embodiment.

Further, the secondary circuit of the flyback power supply circuit 1E illustrated in FIG. 27 includes the charge current control unit 6, the charging unit 7, the film capacitors C13 and C14, the output voltage switching unit 14 to which the output voltage switching signal SS is input, and the switch controller 15 that controls ON and OFF of the first electronic switch S1 and the second electronic switch S2.

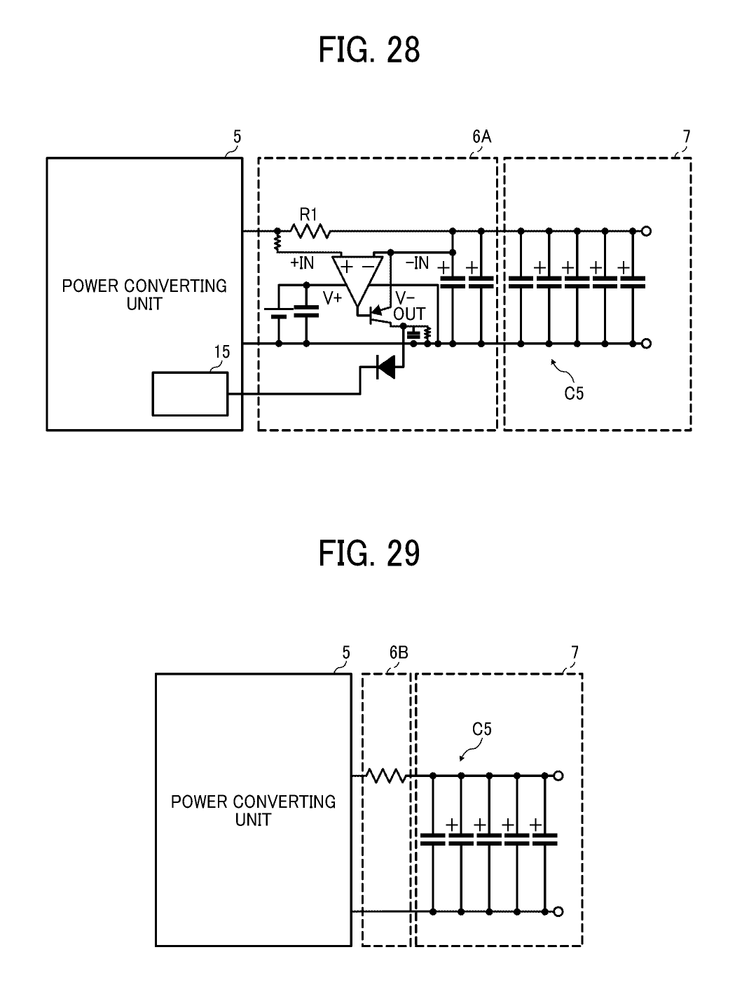

FIGS. 28 and 29 illustrate configuration examples of the charge current control unit 6 that controls the charge current to the charging unit 7. For example, as illustrated in FIG. 28, the charge current control unit 6 may include a feedback circuit 6A that detects a current with a sensor resistor R1 (i.e., a current sensor), amplifies the detected current with an operational amplifier, and feeds the amplified current back to the switch controller 15 to control the first electronic switch S1 and the second electronic switch S2.

If the sensor resistor R1 is configured to be variable or externally controllable, it is possible to speed up the charging to the charging unit 7 when the semiconductor laser 40 requires further current for some reason, for example.

Alternatively, the charge current control unit 6 may include a charging resistor 6B, as illustrated in FIG. 29. However, a configuration that performs feedback control with the feedback circuit 6A reduces power loss more efficiently than a configuration using the charging resistor 6B, achieving higher efficiency.

As illustrated in FIGS. 28 and 29, the plurality of capacitors connected in parallel to form the charging unit 7 will be collectively referred to as the output capacitor C5.

The output capacitor C5 of the charging unit 7 may be electrolytic capacitors. The lifetime of an electrolytic capacitor is reduced with an increase in ambient temperature. For example, according to the Arrhenius equation, the lifetime of the electrolytic capacitor halves with each 10° C. increase in ambient temperature and doubles with each 10° C. reduction in ambient temperature. Further, as illustrated in TABLE 1 given below, there is also a case in which the lifetime of the electrolytic capacitor halves with each 5° C. increase in ambient temperature and doubles with each 5° C. reduction in ambient temperature.

TABLE 1

| ambient temperature (° C.) | life expectancy (hours) |
|---|---|
| 105 | 2000 |
| 100 | 4000 |
| 95 | 8000 |
| 90 | 16000 |
| 85 | 32000 |

If a ripple current flows through the electrolytic capacitor, therefore, heat is generated inside the electrolytic capacitor, reducing the lifetime of the electrolytic capacitor. It is thus preferable to connect the film capacitor C13 to the stage preceding the coil L2 (choke coil) as illustrated in FIG. 26, or connect the film capacitor C14 to the stage preceding the output capacitor C5 (i.e., the charging unit 7) as illustrated in FIGS. 26 and 27. This configuration prevents the ripple current from flowing through the output capacitor C5, thereby suppressing heat generation in the output capacitor C5 and extending the lifetime of the power supply device 1′.

A description will now be given of other effects of the power supply device 1 according to the first embodiment and the power supply device 1′ according to the second embodiment and the calculation of the output voltage using simulation circuits.

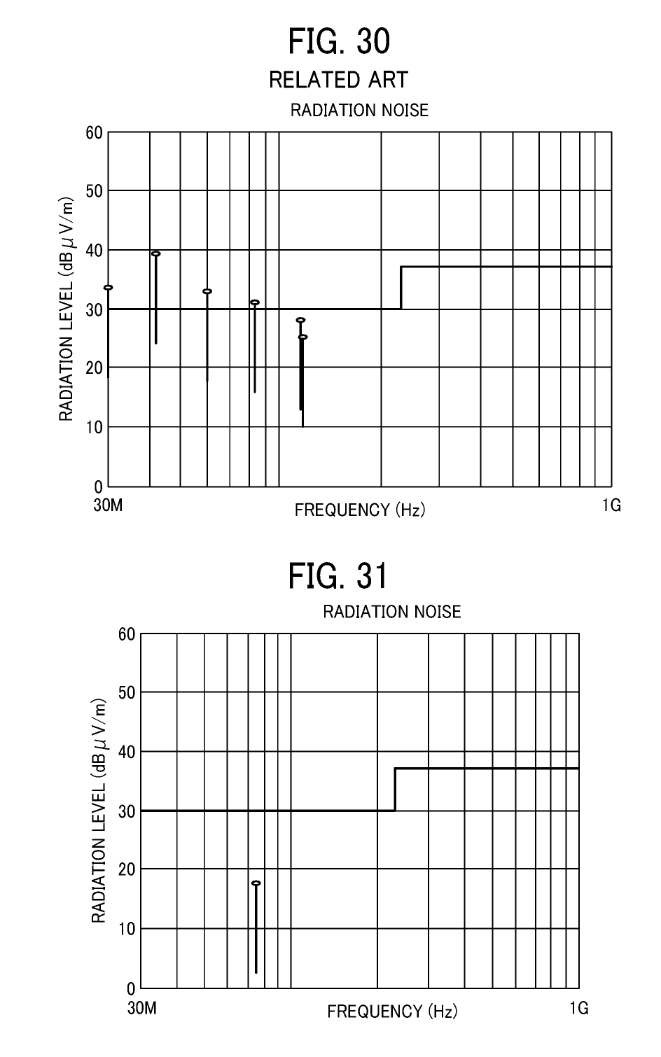

The first and second embodiments reduce unnecessary radiation noise. FIG. 30 is a graph illustrating unnecessary radiation noise from a single-switch flyback power supply circuit as a comparative example, and FIG. 31 is a graph illustrating unnecessary radiation noise from the flyback power supply circuit 1E according to the second embodiment illustrated in FIG. 27. In the drawings, the horizontal axis represents the frequency (Hz), and the vertical axis represents the radiation level (dBμV/m). In the drawings, a bold solid line indicates the limit value for Class B information technology equipment used in a domestic or residential environment, specified by the Voluntary Control Council for Interference by Information Technology Equipment (VCCI) in Japan.

As illustrated in FIGS. 30 and 31, a surge hardly occurs in the power supply device 1′ according to the second embodiment, since the second diode D2 clamps the drain-source voltage Vds of each of the first electronic switch S1 and the second electronic switch S2. Consequently, unnecessary radiation noise is reduced.

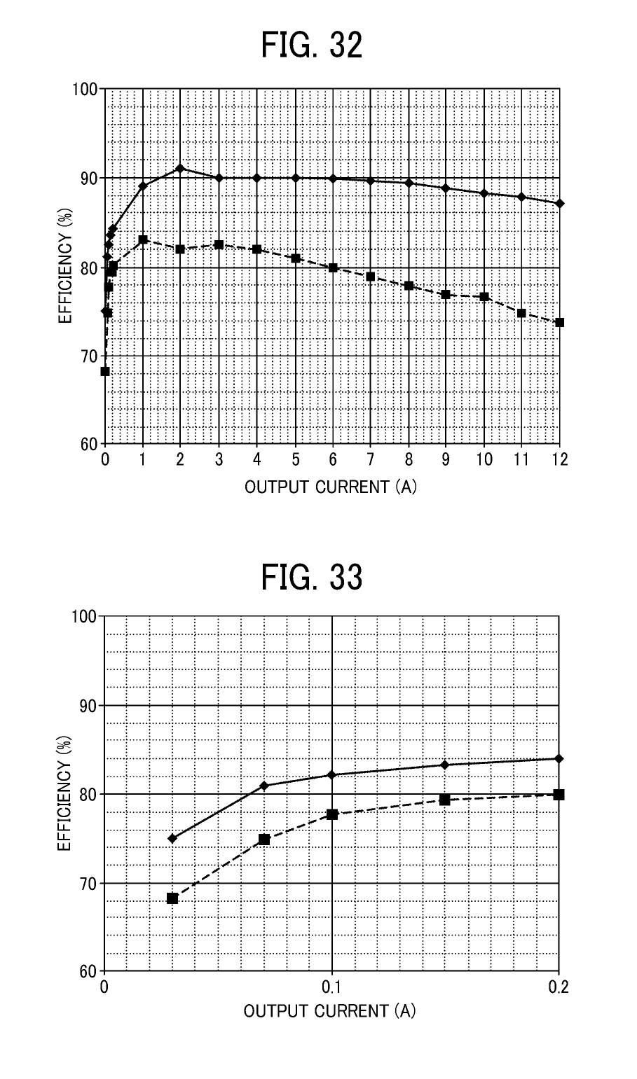

The first and second embodiments also improve efficiency. FIG. 32 is a graph illustrating the efficiency of the flyback power supply circuit 1E according to the second embodiment illustrated in FIG. 27 under a heavy load of 12 A, as compared with the efficiency of the single-switch flyback power supply circuit as a comparative example. FIG. 33 is a graph illustrating the efficiency of the flyback power supply circuit 1E according to the second embodiment illustrated in FIG. 27 under a light load of 0.07 A, as compared with the efficiency of the single-switch flyback power supply circuit as a comparative example. In the drawings, the horizontal axis represents the output current (A), and the vertical axis represents the efficiency (%). Further, a solid line indicates the result of the present embodiment, and a broken line indicates the result of the comparative example.

As illustrated in FIGS. 32 and 33, whereas the single-switch flyback power supply circuit according to the comparative example has an efficiency of 74.0% under the heavy load and an efficiency of 74.8% under the light load, the flyback power supply circuit 1E according to the present embodiment has an efficiency of 87.5% under the heavy load and an efficiency of 81.0% under the light load, which confirms the improvement in efficiency in the flyback power supply circuit 1E according to the present embodiment.

The calculation of the output voltage using a simulation circuit of the forward power supply circuit 1D and a simulation circuit of the flyback power supply circuit 1E will now be described.

The calculation of the output voltage using a simulation circuit of the forward power supply circuit 1D will first be described.

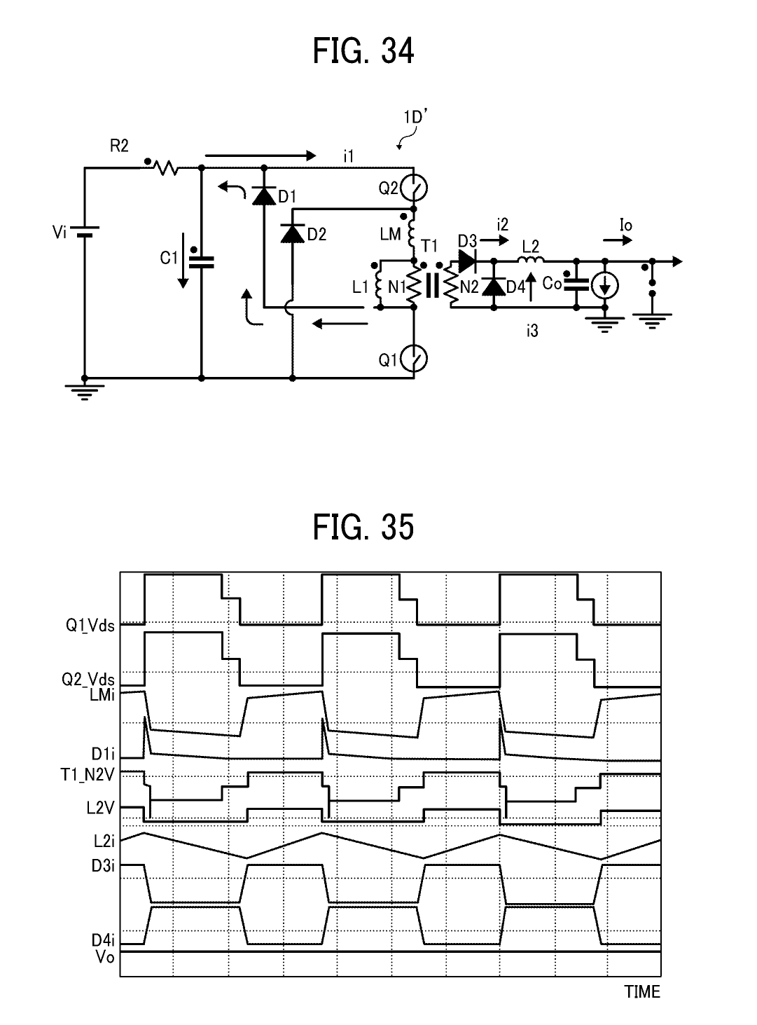

FIG. 34 illustrates a simulation circuit 1D′ of the forward power supply circuit 1D, and FIG. 35 illustrates simulation results obtained from respective units of the simulation circuit 1D′; a drain-source voltage Q1_Vds of an electronic switch Q1, a drain-source voltage Q2_Vds of an electronic switch Q2, a current LMi flowing through a coil LM, a current D1i flowing through the first diode D1, a voltage T1_N2V induced in a secondary winding N2 of the transformer T1, a voltage L2V at the coil L2, a current L2i flowing through the coil L2, a current D3i flowing through the third diode D3, a current D4i flowing through the fourth diode D4, and an output voltage Vo.

The output voltage Vo from the simulation circuit 1D′ illustrated in FIG. 34 may be calculated as follows.

When electronic switches Q1 and Q2 are turned on, an input voltage Vi is applied to a primary winding N1 of the transformer T1. Herein, the voltage T1_N2V induced in the secondary winding N2 of the transformer T1 is expressed by the following equation (1).

T1_{—}N2V=N2/N1·Vi (1)

The voltage T1_N2V biases the third diode D3 in the forward direction, and a secondary-side current i2 flows. During the ON period of the electronic switches Q1 and Q2, the secondary-side current i2 continues to flow through the third diode D3, the choke coil L2, and a capacitor Co, i.e., through a path for charging the capacitor Co serving as a smoothing capacitor. The voltage L2V obtained at opposed ends of the choke coil L2 during this period is expressed by the following equation (2).

L2V=T1_{—}N2V−Vo=N2/N1·Vi−Vo (2)

The secondary-side current i2 is expressed by the following equation (3), wherein Ton represents the ON period of the electronic switches Q1 and Q2.

Δi2=L2V/L2′·Ton=T1_{—}N2V−Vo/L2′·Ton (3)

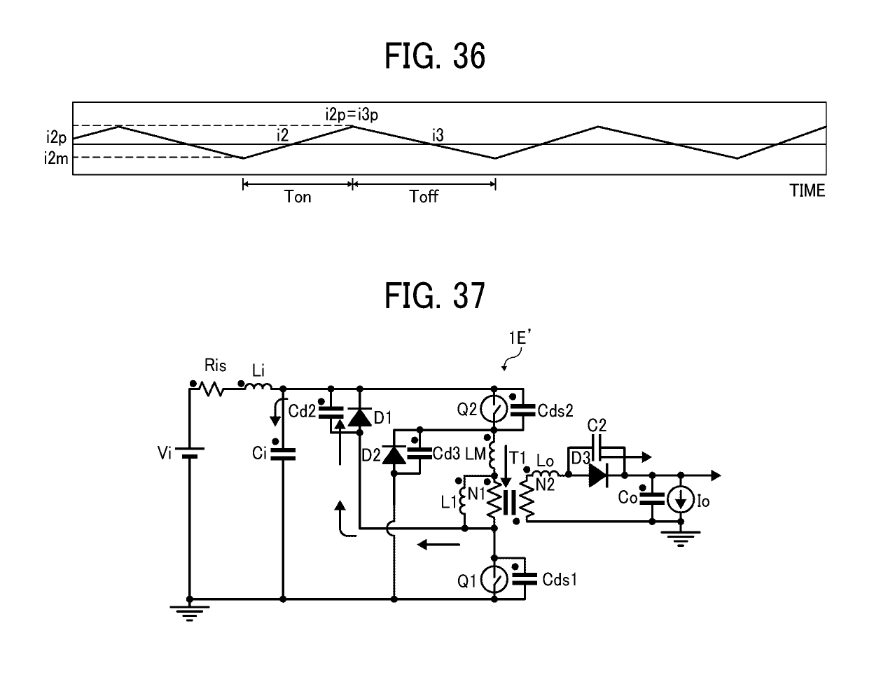

The waveform of the secondary-side current i2 is illustrated in FIG. 36. FIG. 36 also illustrates the waveform of a later-described current i3, a maximum value i2p and a minimum value i2m of the secondary-side current i2, a maximum value i3p of the current i3, and an OFF period Toff of the electronic switches Q1 and Q2.

During the ON period of the electronic switches Q1 and Q2, energy PL2 is stored in the choke coil L2 with the maximum value i2p of the secondary-side current i2. The energy PL2 is expressed by the following equation (4).

PL2=½L2′·i2p² (4)

When the electronic switches Q1 and Q2 are turned off, the primary circuit loses power, and counter electromotive force is generated in the choke coil L2. Then, the current i3 starts flowing with the maximum value i2p of the secondary-side current i2. During the OFF period of the electronic switches Q1 and Q2, the current i3 continues to flow through the choke coil L2, the capacitor Co, and the fourth diode D4. Since the polarity of the voltage L2V at the opposed ends of the choke coil L2 is reversed during this period, the following equation (5) holds.

L2V=Vo (5)

Further, the current i3 is expressed by the following equation (6).

Δi3=Vo/L2′·Toff (6)

Since a current continuously flows through the choke coil L2 during the control of the output voltage Vo, the following equation (7) holds.

Δi2=Δi3 (7)

Accordingly, the following equation (8) is derived.

T1_{—}N2V−Vo/L2′·Ton=Vo/L2′·Toff (8)

If a switching frequency sf is fixed, the output voltage Vo is controllable by the adjustment of the ON period Ton based on the following equations (9) to (11), in which D represents the duty cycle and T represents the switching period (i.e., T=Ton+Toff).

Vo=Ton/Ton+Toff·T1_{—}N2V−Vo=Ton·sf·N2/N1·Vi (9)

sf=1/(Ton+Toff) (10)

D=Ton/T=Ton/Ton+Toff (11)

As described above, it is possible to control the output voltage Vo to be constant by changing the duty cycle D, i.e., the ratio of the ON period Ton of the electronic switches Q1 and Q2.

The calculation of the output voltage Vo using a simulation circuit of the flyback power supply circuit 1E will now be described.

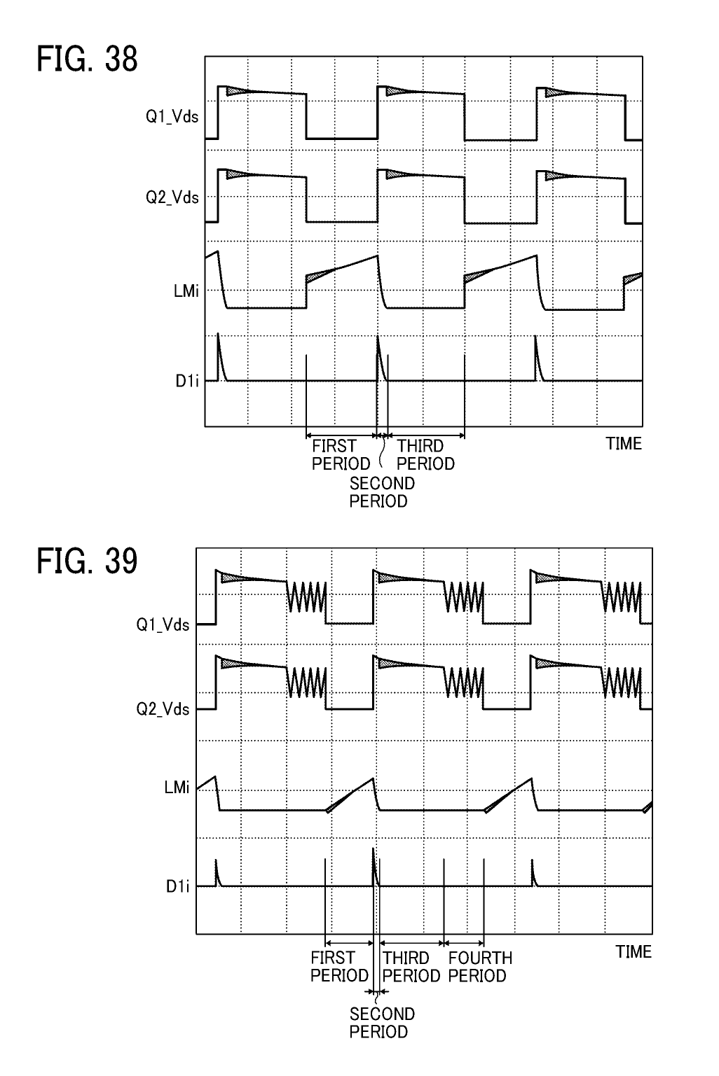

FIG. 37 illustrates a simulation circuit 1E′ of the flyback power supply circuit 1E. FIG. 38 illustrates simulation results obtained from respective units of the simulation circuit 1E′ under a heavy load, and FIG. 39 illustrates simulation results obtained from the respective units of the simulation circuit 1E′ under a light load.

Although the operation of the secondary circuit of a dual-switch flyback power supply circuit is the same as that of a single-switch flyback power supply circuit, analysis reveals that the dual-switch flyback power supply circuit has different operation modes between the heavy load and the light load, i.e., a continuous current mode under the heavy load and a discontinuous current mode under the light load. Accordingly, different calculation methods are employed for the two modes.

The output voltage Vo from the simulation circuit 1E′ illustrated in FIG. 37 may be calculated as follows.

In a first period in FIGS. 38 and 39, in which the electronic switches Q1 and Q2 are ON and the diodes D2 and D3 are OFF, the electronic switches Q1 and Q2 are simultaneously turned on, causing a current to flow through the primary circuit on the primary side of the transformer T1 and store energy in the coils L1 and LM. During this period, an output current Io does not flow from the third diode D3 in the secondary circuit.

In a second period in FIGS. 38 and 39, in which the electronic switches Q1 and Q2 are OFF and the diodes D2 and D3 are ON, the voltage is sharply increased by the self-inductance due to the sudden cut-off of the current following the turn-off of the electronic switches Q1 and Q2. The thus-sharply increased voltage (i.e., a combination of a surge voltage and a spike voltage) is regenerated in a capacitor Ci in the primary circuit by the electronic switches Q1 and Q2 and the diodes D1 and D2. During this period, the output current Io flows, and the drain-source voltage of each of the electronic switches Q1 and Q2 becomes substantially equal to the input voltage Vi.

In a third period in FIGS. 38 and 39, in which the electronic switches Q1 and Q2 are OFF and the diodes D2 and D3 are ON, the energy stored in the primary coil N1 of the transformer T1 continues to be discharged. During this period, the output current Io flows.

In a fourth period in FIGS. 38 and 39, in which the electronic switches Q1 and Q2 are OFF and the diodes D2 and D3 are OFF, i.e., an inactive period, the output current Io does not flow.

The continuous current mode under the heavy load and the discontinuous current mode under the light load will now be described.

In the continuous current mode under the heavy load, energy is stored in the transformer T1 during the first period and discharged to the secondary circuit during the second and third periods. Thus, a voltage conversion ratio M of the simulation circuit 1E′ equals to that of a single-switch flyback power supply circuit, as expressed by the following equation (12), wherein the duty cycle D is set within a range from 0 to 0.5.

M=Vo/Vi=1/n·D/1−D (12)

In the discontinuous current mode under the light load, energy is stored during the first period and discharged during the second and third periods. Thus, the voltage conversion ratio M is expressed by the following equation (13), wherein D1′ represents the duty cycle of the second and third periods.

M=Vo/Vi=1/n·D/D1′ (13)

To derive the duty cycle Dr, it is necessary to calculate the maximum value of an excitation current flowing through the transformer T1. When the maximum value of the excitation current flowing through the transformer T1 is represented as Δi, the following equation (14) is derived in which Lm represents the excitation inductance (i.e., primary inductance) of the transformer T1 and Lr represents the leakage inductance on the primary side of the transformer T1.

Δi=Vi·DT/(Lm+Lr)=Vi·DT/sf(Lm+Lr) (14)

Based on the equation (14), the following equation (15) of the output current To is obtained.

Io=½D1′·ΔiLm·n=n·Vi·D·D1′/2sf(Lm+Lr) (15)

When Ro represents an output load resistance, Io=Vo/Ro holds. Thus, the following equation (16) is obtained from the equations (14) and (15).

Vo/Vi=n·D·D1′Ro/2sf(Lm+Lr) (16)

Further, the duty cycle D1′ is expressed by the following equation (17) based on the equations (13) and (16).

D1′=1/n·√2sf(Lm+Lr)/Ro (17)

Accordingly, the voltage conversion ratio M is obtained from the following equation (18) with the duty cycle D1′ substituted in the equation (13).

M=D √Ro/2sf(Lm+Lr)/ (18)

According to an embodiment of this disclosure, a small, high-efficiency power supply device is provided.

The above-described embodiments are illustrative and do not limit this disclosure. Thus, numerous additional modifications and variations are possible in light of the above teachings. For example, elements or features of different illustrative and embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein. It is therefore to be understood that, within the scope of the appended claims, this disclosure may be practiced otherwise than as specifically described herein.

What is claimed is:

1. A power supply device comprising:
a power converter transformer including a primary winding and a secondary winding;
a coil provided on a primary side of the power converter transformer, and having a first end connected in series to a first end of the primary winding of the power converter transformer to store energy;
a first capacitor provided on the primary side of the power converter transformer, and in which the stored energy is regenerated; and
an energy regeneration circuit provided on the primary side of the power converter transformer to regenerate the stored energy in the first capacitor.

2. The power supply device according to claim 1, wherein the energy regeneration circuit includes a first electronic switch connected to a second end of the coil opposed to the first end of the coil and a second electronic switch connected to a second end of the primary winding opposed to the first end of the primary winding.

3. The power supply device according to claim 2, further comprising:
a second capacitor and a first resistor connected in parallel to the first electronic switch; and
a third capacitor and a second resistor connected in parallel to the second electronic switch.

4. The power supply device according to claim 2, wherein the energy regeneration circuit further includes a first diode to store the energy of the coil in the first capacitor and a second diode to clamp a surge voltage.

5. The power supply device according to claim 1, further comprising a synchronous rectifier circuit provided on a secondary side of the power converter transformer, and including Schottky barrier diodes connected in parallel to parasitic diodes of the synchronous rectifier circuit.

6. The power supply device according to claim 5, further comprising a switch circuit to cut off the synchronous rectifier circuit in accordance with a magnitude of a load connected to the secondary side of the power converter transformer.

7. The power supply device according to claim 1, further comprising:
a charging unit provided on a secondary side of the power converter transformer, and including a plurality of capacitors connected in parallel; and
a charge current control unit to control a charge current to the charging unit.

8. The power supply device according to claim 7, wherein the charge current control unit includes a feedback circuit including a current sensor to detect a current and controlling the charge current to the charging unit based on a detection result obtained from the current sensor.

9. An image forming apparatus comprising:
an image forming unit to form an image;
a control unit to control the image forming unit; and
the power supply device according to claim 1.

10. A laser device comprising:
a laser to emit laser beams; and
the power supply device according to claim 7 to supply power to the laser to oscillate.

11. A laser ignition device comprising:
the laser device according to claim 10; and
an optical system to collect the laser beams emitted from the laser device onto an object to ignite the object.

12. An electronic device comprising the power supply device according to claim 1.
